(19) United States
(12) Patent Application Publication
(10) Pub. No.: US 2017/0171523 A1
(43) Pub. Date: Jun. 15, 2017

(54) Assisted Auto White Balance

(71) Applicant: Motorola Mobility LLC, Chicago, IL (US)

(72) Inventors: Daniela Radakovic, Park Ridge, IL (US); John C. Pincenti, Chicago, IL (US)

(21) Appl. No.: 14/964,747

(22) Filed: Dec. 10, 2015

(51) Int. Cl. H04N 9/73; G06K 9/46; H04N 5/225; G06T 7/00; H04N 5/247

(52) U.S. Cl. CPC H04N 9/735; G06T 7/0051; H04N 5/247; H04N 5/2256; G06K 9/4661; G06K 2009/4666

(57) ABSTRACT

Assisted auto white balance is described to improve the overall quality of a captured image, particularly for a single image scene that contains more than one type of illumination. An image is obtained, partitioned into a plurality of regions, and at least some of the regions are independently white balanced. In some embodiments, a depth map is constructed for the image and used to partition the image into a plurality of regions, at least some of which are independently white balanced. For each independently white balanced region, an illuminant is determined. A decision is then made to white balance the image according to one or more of the determined illuminants.

### BACKGROUND

When viewing a scene, the human visual system is naturally able to subtract out the color of ambient lighting, resulting in color constancy. For instance, while incandescent light is more yellow/orange than daylight, a piece of white paper will always appear white to the human eye under either lighting condition. In contrast, when a camera captures the scene as an image, it is necessary to perform color correction, or white balance, to subtract out the lighting's color contribution and achieve color constancy in the image. Conventionally, white balance is automatically performed on a captured image by applying automatic white balance (AWB) techniques that color correct the image based on a single lighting type, or illuminant, determined for the image. When multiple illuminants are present, however, current AWB techniques often fail, resulting in poor image quality.

### BRIEF DESCRIPTION OF THE DRAWINGS

While the appended claims set forth the features of the present techniques with particularity, these techniques, together with their objects and advantages, may be best understood from the following detailed description taken in conjunction with the accompanying drawings of which:

FIG. 1 is an overview of a representative environment in which the present techniques may be practiced;

FIG. 2 illustrates an example implementation in which assisted white balancing can be employed by partitioning the image into regions;

FIG. 3 illustrates an example flow diagram in which assisted white balancing is employed by partitioning the image into regions

FIG. 4 illustrates an example implementation in which assisted white balancing can be employed by using information from a depth map;

FIG. 5 illustrates an example flow diagram in which assisted white balancing is employed by using information from a depth map;

FIG. 6 illustrates an example implementation in which assisted white balancing can be employed globally to an image;

FIG. 7 illustrates an example implementation in which assisted white balancing can be employed locally to an image; and

FIG. 8 illustrates an example system including various components of an example device that can use the present techniques.

### DETAILED DESCRIPTION

Turning to the drawings, wherein like reference numerals refer to like elements, techniques of the present disclosure are illustrated as being implemented in a suitable environment. The following description is based on embodiments of the claims and should not be taken as limiting the claims with regard to alternative embodiments that are not explicitly described herein.

The capability of the human visual system to map object color to the same value regardless of environmental illuminant is known as color constancy. For example, to the human eye white paper will always be identified as white under many illuminants. In image cameras, however, object color is the result of object reflectance as well as various illuminant properties. Consequently, for accurate images, object color contribution from the illuminant must be accounted for and corrected in the image. This type of color correction is known as white balance, and is used to achieve color constancy for the image similar to that observed by the human visual system for real objects. In a typical camera system, white balancing is automatically performed on an image by applying one or more auto white balance (AWB) algorithms. The AWB algorithms may determine a single illuminant upon which the color correction of the entire image is to be based. However, these AWB algorithms are prone to failure when multiple illuminants, such as natural light and artificial light, are present which, in turn, can result in substandard quality of the final image.

The embodiments described herein provide assisted auto white balance effective to significantly improve image quality, particularly for a single image scene that contains more than one type of illumination. Some embodiments partition an image into a plurality of regions and independently white balance at least some of the individual regions. The white-balanced regions are analyzed to produce results, such as determining an illuminant for each region. The results are used to make a final decision to white balance the image according one or more of the determined illuminants.

Some embodiments obtain an image and construct a depth map for the image. The depth map is then used to white balance the image. For example, the depth map can be used to partition the image into a plurality of regions. The depth-based regions are independently white balanced and analyzed to produce results, such as determining an illuminant for the depth-based regions. The results are used to make a final decision to white balance the image according to one or more of the determined illuminants.

Example Environment

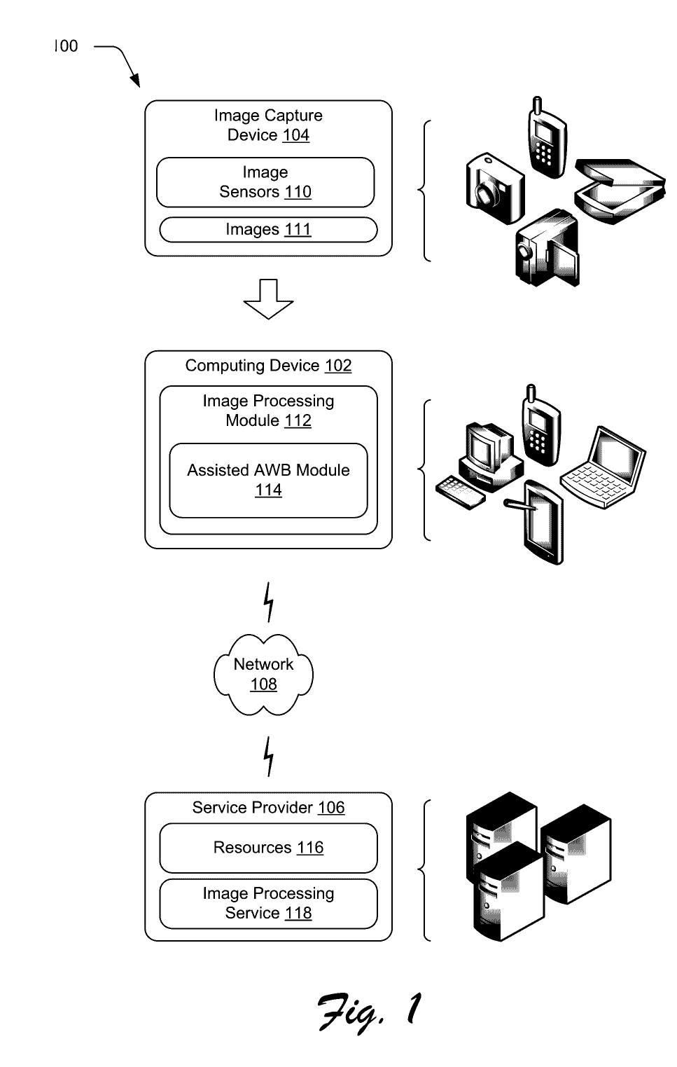

FIG. 1 is an illustration of an environment 100 in an example implementation that is operable to employ techniques described herein. The illustrated environment 100 includes a computing device 102 and an image capture device 104, which may be configured in a variety of ways. Additionally, the computing device 102 may be communicatively coupled to one or more service providers 106 over a network 108, such as the Internet. Generally speaking, a service provider 106 is configured to make various resources (e.g., content, services, web applications, etc.) available over the network 108, to provide a “cloud-based” computing environment and web-based functionality to clients.

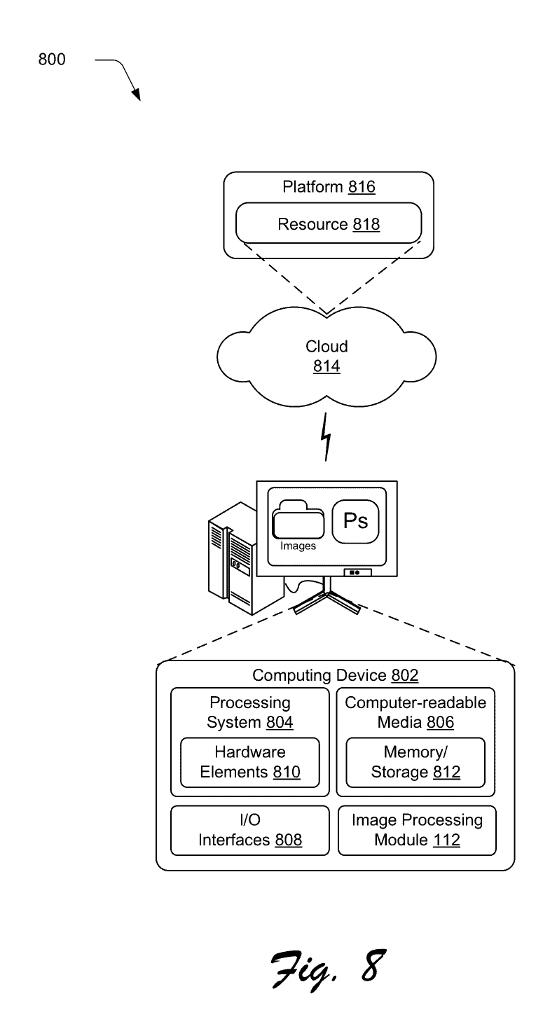

The computing device 102 may be configured as a desktop computer, a laptop computer, a mobile device (e.g., assuming a handheld configuration such as a tablet or mobile phone), and so forth. Thus, the computing device 102 may range from full resource devices with substantial memory and processor resources (e.g., personal computers, game consoles) to a low-resource device with limited memory and processing resources (e.g., mobile devices). Additionally, although a single computing device 102 is shown, the computing device 102 may be representative of a plurality of different devices to perform operations. Additional details and examples regarding various configurations of computing devices, systems, and components suitable to implement aspects of the techniques described herein are discussed in relation to FIG. 8 below.

The image capture device 104 may also be configured in a variety of ways. Examples of such configurations include a video camera, scanner, copier, camera, mobile device (e.g., smart phone), and so forth. Other implementations are contemplated in which the image capture device 104 may be representative of a plurality of different devices configured to capture images. Although the image capture device 104 is illustrated separately from the computing device 102, the image capture device 104 may be configured as part of the computing device 102, e.g., for a tablet configuration, a laptop, a mobile phone or other implementation of a computing device having a built in image capture device 104. The image capture device 104 is illustrated as including image sensors 110 that are configured to capture images 111. In general, the image capture device 104 may capture and provide images 111 via the image sensors 110. These images may be stored on and further processed by the image capture device 104 or computing device 102 in various ways. Naturally, images 111 may be obtained in other ways also such as by downloading images from a website, accessing images from some form of computer readable media, and so forth.

The images 111 may be obtained by an image processing module 112. Although the image processing module 112 is illustrated as being implemented on a separate device it should be readily apparent that other implementations are also contemplated in which the image sensors 110 and image processing module 112 are implemented on the same device. Further, although the image processing module is illustrated as being provided by a computing device 102 in a desktop configuration, a variety of other configurations are also contemplated, such as remotely over a network 108 as a service provided by a service provider, a web application, or other network accessible functionality.

Regardless of where implemented, the image processing module 112 is representative of functionality that is operable to manage images 111 in various ways. Functionality provided by the image processing module 112 may include, but is not limited to, functionality to organize, access, browse and view images, as well as to perform various kinds of image processing operations upon selected images. By way of example and not limitation, the image processing module 112 may include or otherwise make use of an assisted AWB module 114.

The assisted AWB module 114 is representative of functionality to perform color correction operations related to white balancing of images. The assisted AWB module 114 may be configured to partition an image into a plurality of regions and independently white balance at least some of those regions. The white-balanced regions may be further analyzed to produce results, such as determining an illuminant for the region, which can be used by the assisted AWB module 114 to make a final white balance decision for the image. For example, the image may be white balanced globally or locally. Global white balancing means that all regions of the image are white balanced according to a selected one of the determined illuminants. Local white balancing means that different regions of the image are white balanced differently, according to the illuminant determined for the region.

The assisted AWB module 114 may be further configured to white balance an image based on a depth map constructed for the image. For example, background and foreground objects of the image may be determined according to the depth map. The background and foreground objects may be independently white balanced, and an illuminant may be determined for each object. A final decision may be made by the assisted AWB module 114 regarding white balancing of the image. For example, the image may be white balanced globally or locally, according to one or more of the object-determined illuminants, as discussed herein.

As further shown in FIG. 1, the service provider 106 may be configured to make various resources 116 available over the network 108 to clients. In some scenarios, users may sign up for accounts that are employed to access corresponding resources from a provider. The provider may authenticate credentials of a user (e.g., username and password) before granting access to an account and corresponding resources 116. Other resources 116 may be made freely available, (e.g., without authentication or account-based access). The resources 116 can include any suitable combination of services and content typically made available over a network by one or more providers. Some examples of services include, but are not limited to, a photo editing service, a web development and management service, a collaboration service, a social networking service, a messaging service, an advertisement service, and so forth. Content may include various combinations of text, video, ads, audio, multi-media streams, animations, images, web documents, web pages, applications, device applications, and the like.

For example, the service provider 106 in FIG. 1 is depicted as including an image processing service 118. The image processing service 118 represents network accessible functionality that may be made accessible to clients remotely over a network 108 to implement aspects of the techniques described herein. For example, functionality to manage and process images described herein in relation to image processing module 112 and assisted AWB module 114 may alternatively be implemented via the image processing service 118 or in combination with the image processing service 118. Thus, the image processing service 118 may be configured to provide cloud-based access to functionality that provides for white balancing, as well as other operations described above and below.

Generally, any of the functions described herein can be implemented using software, firmware, hardware (e.g., fixed logic circuitry), manual processing, or a combination of these implementations. The terms “module,” “functionality,” “component” and “logic” as used herein generally represent software, firmware, hardware, or a combination thereof. In the case of a software implementation, the module, functionality, component or logic represents program code that performs specified tasks when executed on or by a processor (e.g., CPU or CPUs). The program code can be stored in one or more computer readable memory devices.

Having described an example operating environment in which various embodiments can be utilized, consider now a discussion of assisted AWB, in accordance with one or more embodiments.

Assisted Auto White Balance

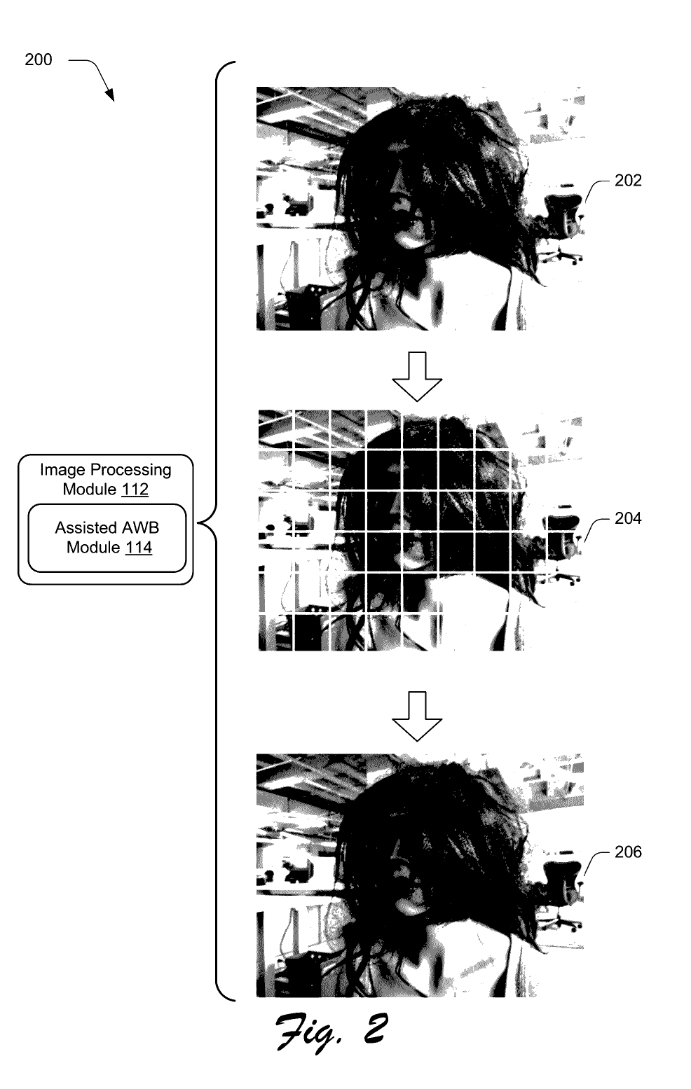

FIG. 2 depicts a system 200 in an example implementation in which an image is white balanced by assisted AWB module 114. The system 200 shows different stages of white balancing an image 202. The image may be obtained directly from one or more image sensors 110 (FIG. 1), from storage upon on some form of computer-readable media, by downloading from a web site, and so on.

As shown in FIG. 2, image 202 is shown prior to white balancing and represents an “as-captured” image. That is, the as-captured image has not been subject to any white balancing to account for the color contribution of environmental illuminants. Image 202 is next partitioned into a plurality of regions to provide a partitioned image 204. The image may be partitioned in a variety of ways and into a variety of regions. As such, partitioning is not limited to the example that is illustrated. For example, partitioned image 204 may be partitioned into any number of regions whose size and/or shape may or may not be uniform. In some embodiments, partitioning an image into its constituent regions may be based on one or more face detection algorithms that look for faces in a particular image.

In one or more embodiments, the image may be partitioned in association with scene statistics that describe color channel values of pixels contained in the image. By way of example and not limitation, color channels may include red (R), green (G), blue (B), green on the red row channel (GR), green on the blue row channel (GB), etc. For instance, scene statistics for each region may include but are not limited to the total number of pixels, the number of pixels for each color channel, the sum of pixel values for each color channel, the average pixel value for each color channel, and ratios of color channel averages (e.g. R:B, R:G, and B:G). Auto white balancing may then be applied to at least some of the partitioned regions of partitioned image 204 using one or more AWB algorithms that take into account the scene statistics for the regions.

As an example, AWB algorithms that may be employed to white balance at least some of the regions can include, but are not limited to, gray world AWB algorithms, white patch AWB algorithms, and illuminant voting algorithms, as will be appreciated by the skilled artisan.

Gray world AWB assumes an equal distribution of all colors in a given image, such that the average of all colors for the image is a neutral gray. When calculated averages for each color channel are equal (or approximately equal), color contribution by environmental illuminants are not considered to be significant, and white balancing the image is not necessary. However, when calculated averages for each color channel are not equal, then one color channel is chosen to be a reference channel and the other color channels are adjusted to equal the average value for the reference channel. For example, in a captured image having unequal averages for red, blue, and green color channels, the green channel is traditionally chosen to be the reference channel. Accordingly, the red and blue channel averages are adjusted, or gained, such that all three color channel averages are equal at the reference channel average value. To white balance the image, the average red channel gain is applied to all red pixels in the image, and the average blue channel gain is applied to all blue pixels in the image. The single set of gains generated by gray world AWB allows for estimation of a single illuminant for the image. However, if multiple illuminants are present in the image, the single set of gains applied by gray world AWB will not adequately correspond to any single illuminant and will generate an unattractive final image.

White patch AWB algorithms assume that the brightest point/pixel in an image is a shiny surface that is reflecting the actual color of the illuminant, and should therefore be white. This brightest point is chosen to be a reference white point for the image, and the color channel values for the point are equalized to the channel having a maximum value. For example, a reference white point includes red, blue, and green color channels, of which the green channel has the highest value. The red and blue channel values for the point are adjusted upward until they are equal with the green channel value. To white balance the image, the red channel gain calculated for the reference point is applied to all red pixels in the image, and the blue channel gain calculated for the reference point is applied to all blue pixels in the image. As with gray world AWB, the single set of gains generated by the white patch AWB technique allows for estimation of a single illuminant for the image. However, if multiple illuminants are present in the image, the single set of gains applied by white patch AWB will not adequately correspond to any single illuminant and will produce an unattractive final image.

Algorithms based on illuminant voting estimate a single most-likely illuminant for an image, and apply an established set of gains corresponding to the illuminant. During image capture, each pixel is given a ‘vote’ for a most-likely illuminant by correlating chromaticity information between the pixel and previously stored illuminant chromaticity. The illuminant with the highest number of votes is selected for the image, and the corresponding set of gains is applied to white balance the image. Consequently, if multiple illuminants are present in the image, the single set of gains applied by the illuminant voting technique will be incorrect for certain pixels, resulting in decreased overall quality of the final image. Other AWB techniques are also contemplated.

Continuing with FIG. 2, at least some of the regions of the partitioned image 204 are independently white balanced using one or more AWB techniques, some of which are described above. The white-balanced regions are further analyzed to produce results including: a determined illuminant for the region, a set of gains determined for the region based on the AWB algorithm(s) applied to the white-balanced region, valid or invalid convergence of the AWB algorithm(s) applied to the white-balanced region, the determined illuminant having the highest occurrence considering the total number of the white-balanced regions, the determined illuminant covering the largest area of the image considering the total area of the white-balanced regions, etc. Based on the results from the individually white-balanced regions of partitioned image 204, the assisted AWB module 114 selects one or more illuminants (or correspondingly one or more sets of gains) according to which the as-captured image 202 will be white balanced to achieve final image 206. In this way, the assisted AWB module 114 makes a decision to white balance the image either globally (i.e. according to one illuminant) or locally (i.e. according to more than one illuminant). For global white balancing, one illuminant is selected and applied to all regions of the image. For local white balancing, different illuminants are applied to different regions of the image. In some embodiments, the assisted AWB module 114 may allow a user to make the decision on whether to white balance the as-captured image 202 globally or locally by presenting the user with selectable options based on the results from the individually white-balanced regions of partitioned image 204.

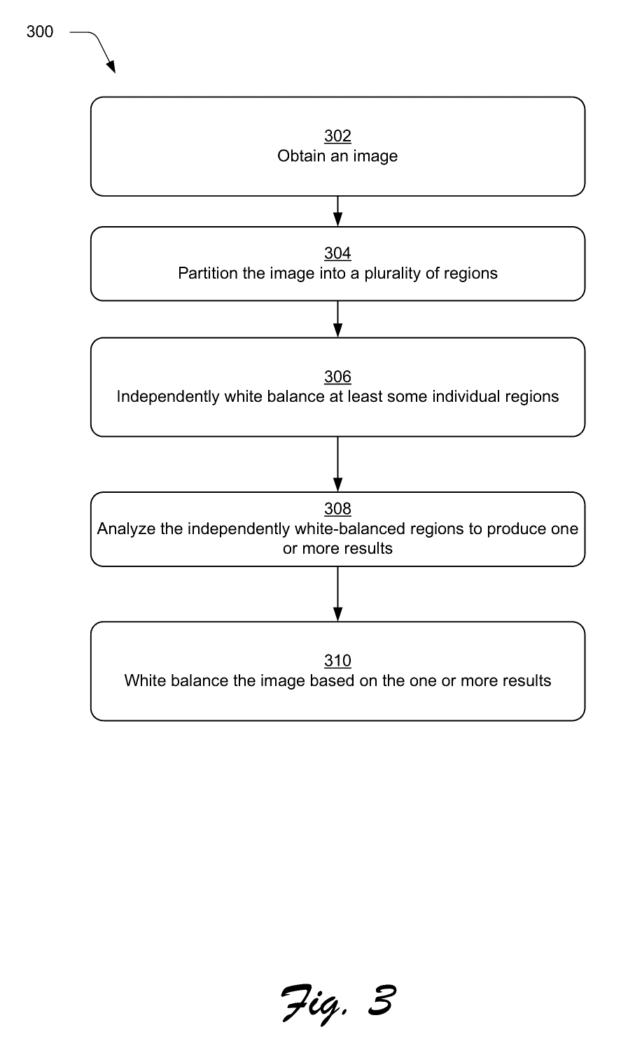

FIG. 3 illustrates a flow diagram 300 that describes steps in a method in accordance with one or more embodiments. The method can be performed by any suitable hardware, software, firmware, or combination thereof. In at least some embodiments, aspects of the method can be implemented by one or more suitably configured software modules, such as image processing module 112 and/or assisted AWB module 114 of FIG. 1.

Step 302 obtains an image. The image may be obtained by image capture device 104 described in FIG. 1, by downloading images from a website, accessing images from some form of computer readable media, and so forth. Step 304 partitions the image into a plurality of regions. Various ways for partitioning the image can be employed, as described above. Step 306 independently white balances at least some individual regions. In some embodiments, each of the plurality of regions may be independently white balanced. The regions may be white balanced according to one or more AWB algorithms, including but not limited to those described herein. In addition, the individual white-balanced regions may be further analyzed to produce results that can be used to make a final white balanced decision. Step 308 analyzes the independently white-balanced regions to produce one or more results. Results of the analysis may include: a determined illuminant for the region, a set of gains determined for the region based on the AWB algorithm(s) applied to the white-balanced region, valid or invalid convergence of the AWB algorithm(s) applied to the white-balanced region, the determined illuminant having the highest occurrence considering the total number of the white-balanced regions, the determined illuminant covering the largest area of the image considering the total area of the white-balanced regions, etc. Step 310 white balances the image based on the one or more results from each of the individually white-balanced regions.

White balancing the image based on the one or more results from each of the individually white-balanced regions can include making a decision, either automatically or manually, regarding whether to white balance the image globally or locally. In cases when the image is white balanced globally, the image is subject to a single set of gains corresponding to a single illuminant selected for the image, and color correction is applied uniformly over the image. It is noted that, even when multiple different illuminants are determined for different regions in step 308, the final decision to white balance the image according to a single illuminant means that some regions will be white balanced according to an illuminant that does not correspond to the region. In cases when the image is white balanced locally, the image is corrected using multiple sets of gains, corresponding to the different illuminants determined for the different regions. Localized white balance may be achieved for each region in an image using a different set of gains for each local illuminant. The image is then white-balanced locally, by region, according to the set of gains determined for that region. Details regarding these and other aspects of assisted AWB techniques are discussed in relation to the following figures.

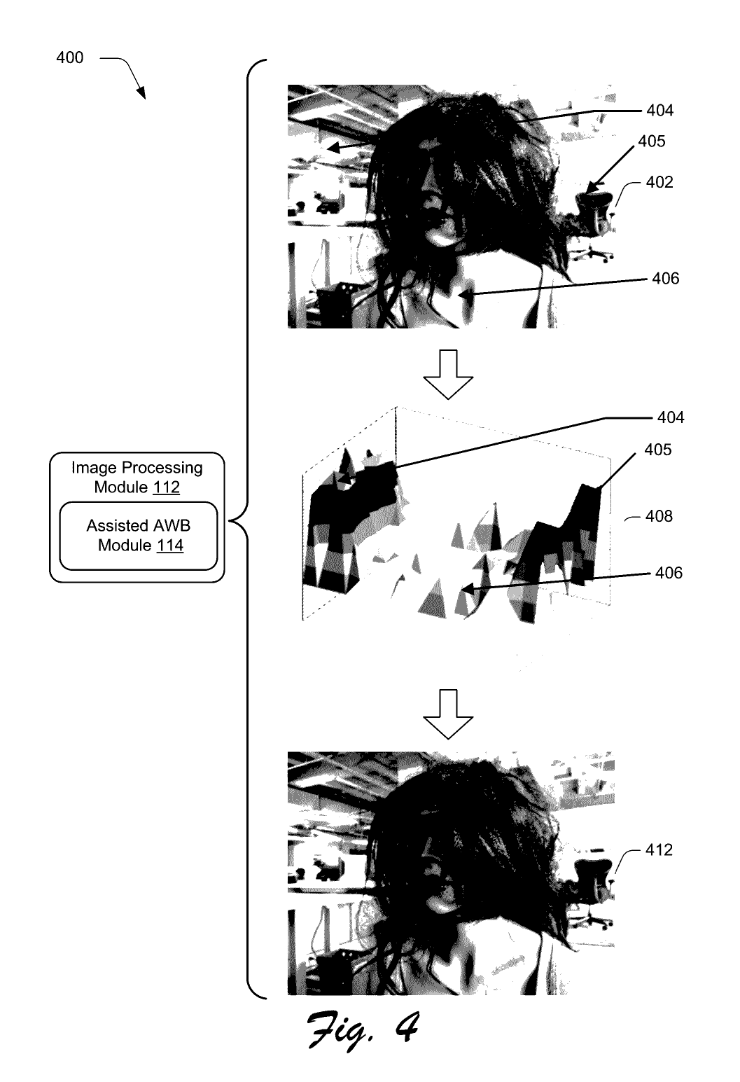

FIG. 4 depicts a system 400 in an example implementation in which an image is white balanced by assisted AWB module 114 of FIG. 1. The system 400 is shown using different illustrative processing stages in which image 402 is white balanced. The image may be obtained, directly from one or more image sensors 110 (FIG. 1), from storage upon on some form of computer-readable media, by downloading from a web site, and so on.

As similarly shown in FIG. 2, FIG. 4 shows image 402 as an as-captured image prior to white balancing. That is, image 402 has not been subject to any white balancing to account for the color contribution of environmental illuminants. In this particular implementation, a depth map 408 is constructed for the image 402. Constructing the depth map may be done in various ways. For example, a single camera equipped with phase detection auto focus (PDAF) sensors functions similarly to a camera with range-finding capabilities. The PDAF sensors, or phase detection pixels, can be located at different positions along the lens such that the sensors receive images ‘seen’ from each slightly different position on the lens. The sensors use the position and separation of these slightly differing images to detect how far out of focus the pixels or object points may be, and accordingly correct the focus before the image is captured in two dimensions. The position and separation information from the PDAF sensors can be further leveraged to combine with the two-dimensional image captured for the image, and a depth map for the image can be constructed.

Alternatively, a depth map can be constructed by using multiple images that are obtained from multiple cameras. In a multiple camera configuration, an image from the perspective of one camera is chosen as the image for which the depth map will be constructed. In this way, one camera captures the image itself and the other camera or cameras function as sensors to estimate disparity values for pixels or object points in the image. The disparity for an object point in an image is a value that is inversely proportional to the distance between the camera and the object point. For example, as the distance from the camera increases, the disparity for that object point decreases. By comparing and combining disparity values for each object point, the depth of an object point can be computed. This allows for depth perception in stereo images. Thus, a depth map for the image can be constructed by mapping the depth of two-dimensional image object points as coordinates in three-dimensional space.

Regardless of how the depth map is constructed, objects can be generally or specifically identified. For example, FIG. 4 shows objects identified as background 404 and 405, as well as foreground 406. In some cases when multiple illuminants are present, there is a likelihood that the different illuminants can affect objects at different depths of the image. For example, objects in the background 404 and 405 may be illuminated by natural light, whereas an object in the foreground 406 may be illuminated by fluorescent light. Depth map 408 can serve to distinguish background and foreground objects, for example, and independent white balancing may be applied to these objects at different locations in the image based on depth. Identified objects may be independently white balanced using one or more AWB techniques, some of which are described above. The white-balanced objects may be further analyzed to produce one or more results, such as an illuminant and corresponding set of gains determined for the object. Other results may include: valid or invalid convergence of the AWB algorithm(s) applied to the white-balanced object, the determined illuminant having the highest occurrence considering the total number of the white-balanced objects, the determined illuminant covering the largest area of the image considering the total area of the white-balanced objects, etc. Based on results from the individually white-balanced object depths given by the depth map 408, the assisted AWB module 114 selects one or more sets of gains according to which the as-captured image 402 will be white balanced to achieve a final image 412. The assisted AWB module 114 can make a decision to white balance the image either globally (i.e. according to one set of gains) or locally (i.e. according to more than one set of gains). In some embodiments, the assisted AWB module 114 may allow a user to make the decision on whether to white balance the as-captured image 402 globally or locally by presenting the user with selectable options based on the results from the individually white-balanced objects given by depth map 408.

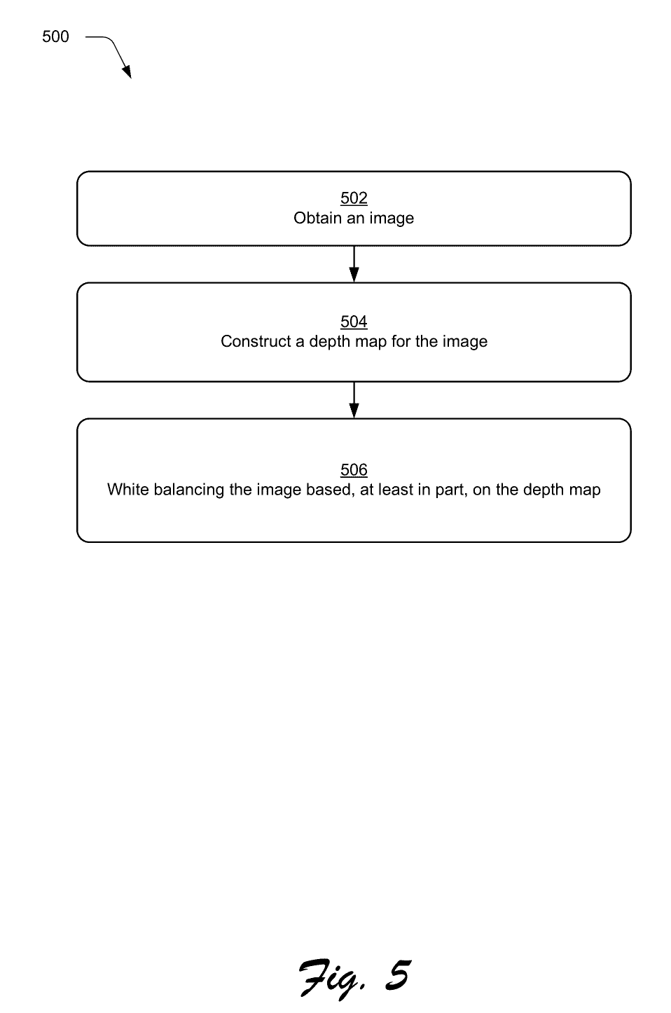

FIG. 5 illustrates a flow diagram 500 that describes steps in a method in accordance with one or more embodiments, such as the example implementation of FIG. 4. The method can be performed by any suitable hardware, software, firmware, or combination thereof. In at least some embodiments, aspects of the method can be implemented by one or more suitably configured software modules, such as image processing module 112 and/or assisted AWB module 114 of FIG. 1.

Step 502 obtains an image. The image may be obtained by image capture device 104 described in FIG. 1, by downloading images from a website, accessing images from some form of computer readable media, and so forth. Step 504 constructs a depth map for the image. Various techniques for constructing the depth map can be employed, examples of which are provided above. Step 506 white balances the image based, at least in part, on the depth map. The image may be white balanced according to one or more AWB algorithms, including but not limited to those described herein. In some embodiments, white balancing the image at step 506 includes partitioning the image into a plurality of regions based on the depth map, and independently white balancing some or all of the regions.

White balancing the image based, at least in part, on the depth map includes making a decision, either automatically or manually, regarding whether to white balance the image globally or locally. In cases when the image is white balanced globally, the image is subject to a single set of gains corresponding to a single illuminant selected for the image, and color correction is applied uniformly over the image. It is noted that, even when multiple different illuminants are determined for different depths of the image (e.g. background and foreground), the final decision to white balance the image according to a single illuminant means that some objects at a given depth may be white balanced according to an illuminant that does not correspond to that particular depth. For cases in which the image is white balanced locally, the image is corrected using multiple sets of gains, corresponding to the different illuminants determined for the different objects. Localized white balance may be achieved for each object in an image using a different set of gains for each local illuminant. The image is then white-balanced locally, by object, according to the set of gains determined for that object. Details regarding these and other aspects of assisted AWB techniques are discussed in relation to the following figures.

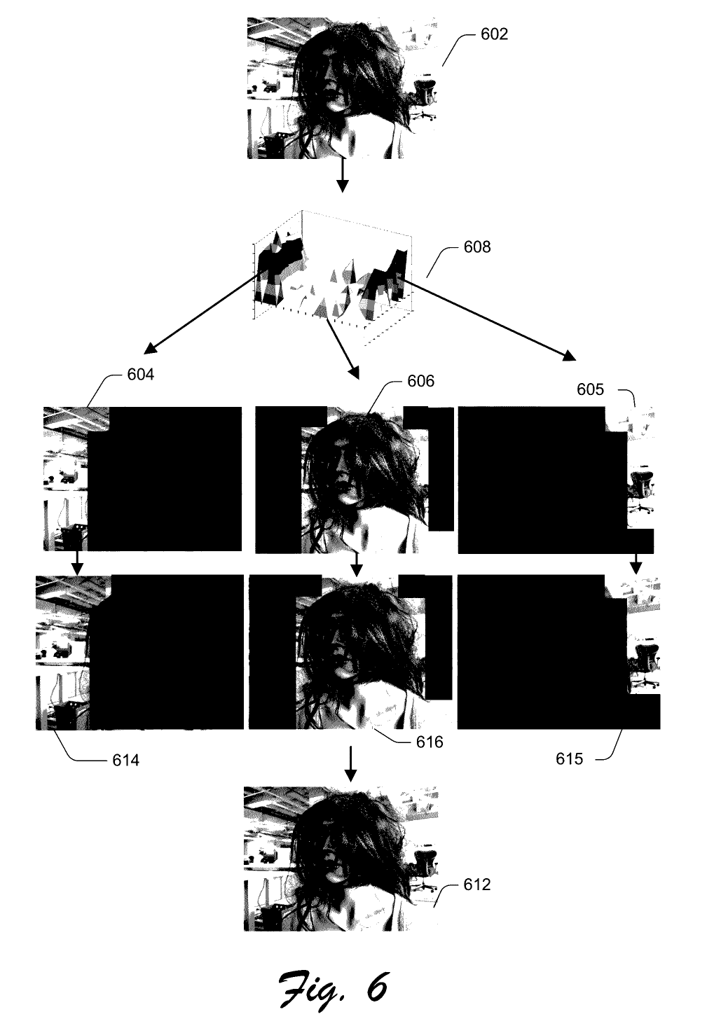

To further illustrate, consider FIG. 6, which shows an as-captured image 602 and its corresponding depth map 608. As-captured image 602 was captured in mixed illuminance, including daylight and fluorescent lighting. The ceiling objects, for example, should be a consistent white color. However, the contribution of different illuminants causes the as-captured image to display inconsistent coloring for the ceiling across the top of the image. In the color version of this figure, there is an observable yellow appearance of the left-side ceiling due to dominating fluorescent illumination, while the right-side ceiling appears white due to the dominating daylight illumination. The dominant foreground illumination for the mannequin object is daylight.

Accordingly, the depth-based background and foreground objects have been determined for the image 602 using information from the depth map 608. Each object is then independently white balanced. Left background 604, right background 605, and foreground 606 are white balanced independently from one another to obtain white-balanced left background 614, white-balanced right background 615, and white-balanced foreground 616, respectively. As a result of applying AWB independently, the white-balanced left background 614 converged on fluorescent light, white-balanced right background 615 converged on daylight, and white-balanced foreground 616 also converged on daylight.

At this point, the assisted AWB module 114 can make a decision (or alternatively offer the decision to a user) regarding how to white balance the entire image. The image may be white balanced globally or locally. In the case of global white balancing of the image, a selected one of the determined illuminants (i.e. either daylight or fluorescent) is chosen. The image is then white-balanced according to the single set of gains corresponding to the selected illuminant. Regarding as-captured image 602, the decision may be made to white balance the image according to the foreground or background. In some embodiments, assisted AWB module 114 may be configured to perform global white balancing of an image based on an ‘intended target,’ which in many cases is likely a foreground object. Regarding FIG. 6, the foreground object 606 was chosen as the intended target. As-captured image 602 was white balanced according to the illuminant determined by white-balanced foreground 616 (i.e. daylight), to generate final image 612. In this example, the left background 604 is incorrectly white-balanced in final image 612, since final image 612 has been white-balanced according to a daylight illuminant instead of the fluorescent illuminant that was actually present at that depth. This may still be considered acceptable because the background was not the intended target, and the quality of the image is not significantly reduced by the appearance of the left background 604 in the final image 612. In the case of assisted white balancing, the assisted AWB module 114 may be configured to automatically or manually decide how to apply global white balance to the image based on results from the independently white balanced objects.

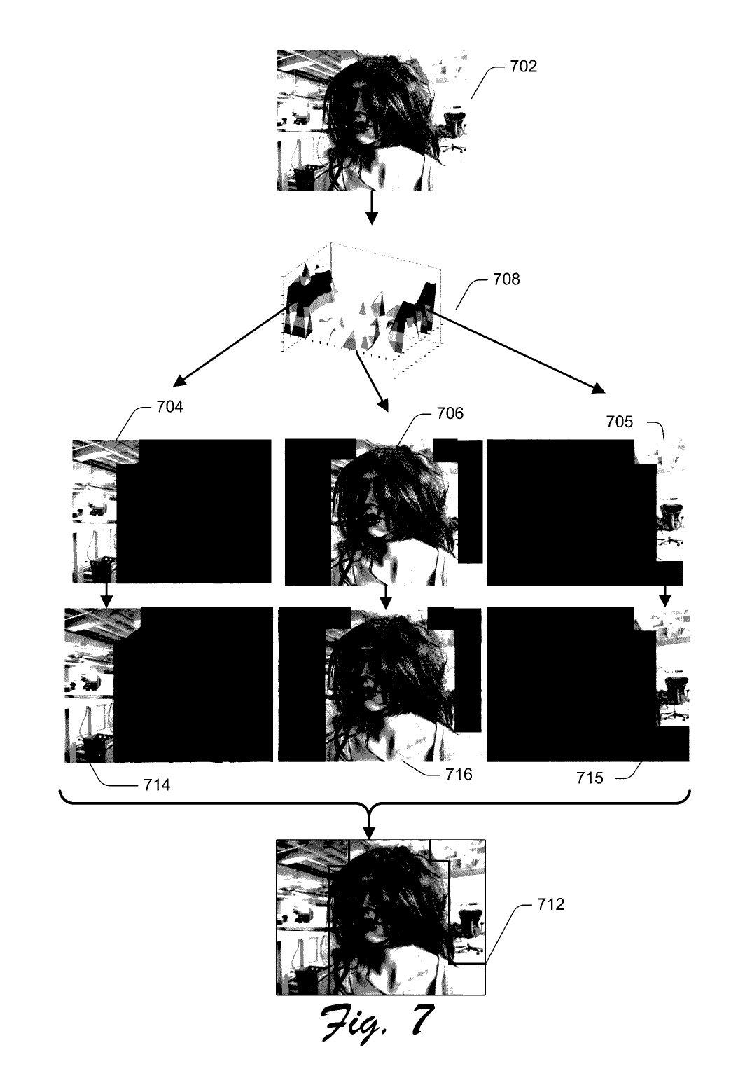

Now consider FIG. 7, which shows as-captured image 702 and its corresponding depth map 708. As described with respect to FIG. 6, as-captured image 702 was captured in mixed illuminance, including daylight and fluorescent lighting.

Similarly, left background 704, right background 705, and foreground 706 are white balanced independently from one another to obtain white-balanced left background 714, white-balanced right background 715, and white-balanced foreground 716, respectively. In applying AWB independently to each depth-based object, the white-balanced left background 714 determined a dominant fluorescent illuminant, white-balanced right background 715 determined a dominant daylight illuminant, and white-balanced foreground 716 also determined daylight as the dominant illuminant.

At this point, the assisted AWB module 114 can make a decision (or alternatively offer the decision up to a user) regarding how to white balance the entire image. The image may be balanced globally or locally. In the case of local white balancing of the image, more than one of the determined illuminants are chosen (in this case both daylight and fluorescence are chosen). Localized white balance may be achieved for each object in an image using a different set of gains for each local illuminant. The image is then white-balanced locally, by object, according to the set of gains determined for that object. In some embodiments, assisted AWB module 114 may be configured to perform local white balancing of an image based on a lack of an intended target. For instance, image quality of some objects may suffer significantly from a global optimization according to an incorrect illuminant, thereby necessitating localized white balance in order to maintain acceptable quality of final image 712. In the case of assisted white balancing, the assisted AWB module 114 may be configured to automatically or manually decide how to apply localized white balance to the image based on results from the independently white balanced objects.

Having considered a discussion of assisted AWB, consider now a discussion of an example device that can be utilized to implement the embodiments described above.

Example Device

FIG. 8 illustrates an example system generally at 800 that includes an example computing device 802 that is representative of one or more computing systems and devices that may implement the various techniques described herein. This is illustrated through inclusion of the image processing module 112, which may be configured to process image data, such as image data captured by an image capture device 104 of FIG. 1. The computing device 802 may be, for example, a server of a service provider, a device associated with a client (e.g., a client device), an on-chip system, or any other suitable computing device or computing system.

The example computing device 802 as illustrated includes a processing system 804, one or more computer-readable media 806, and one or more I/O interface 808 that are communicatively coupled, one to another. Although not shown, the computing device 802 may further include a system bus or other data and command transfer system that couples the various components, one to another. A system bus can include any one or combination of different bus structures, such as a memory bus or memory controller, a peripheral bus, a universal serial bus, or a processor or local bus that utilizes any of a variety of bus architectures. A variety of other examples are also contemplated, such as control and data lines.

The processing system 804 is representative of functionality to perform one or more operations using hardware. Accordingly, the processing system 804 is illustrated as including hardware element 810 that may be configured as processors, functional blocks, and so forth. This may include implementation in hardware as an application specific integrated circuit or other logic device formed using one or more semiconductors. The hardware elements 810 are not limited by the materials from which they are formed or the processing mechanisms employed therein. For example, processors may be comprised of semiconductor(s) and transistors (e.g., electronic integrated circuits (ICs)). In such a context, processor-executable instructions may be electronically-executable instructions.

The computer-readable storage media 806 is illustrated as including memory/storage 812. The memory/storage 812 represents memory/storage capacity associated with one or more computer-readable media. The memory/storage component 812 may include volatile media (such as random access memory (RAM)) or nonvolatile media (such as read only memory (ROM), Flash memory, optical disks, magnetic disks, and so forth). The memory/storage component 812 may include fixed media (e.g., RAM, ROM, a fixed hard drive, and so on) as well as removable media (e.g., Flash memory, a removable hard drive, an optical disc, and so forth). The computer-readable media 806 may be configured in a variety of other ways as further described below.

Input/output interface(s) 808 are representative of functionality to allow a user to enter commands and information to computing device 802, and also allow information to be presented to the user and other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 802 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 802. By way of example, and not limitation, computer-readable media may include “computer-readable storage media” and “computer-readable signal media.”

“Computer-readable storage media” refers to media and devices that enable storage of information in contrast to mere signal transmission, carrier waves, or signals per se. Thus, computer-readable storage media does not include signal bearing media or signals per se. The computer-readable storage media includes hardware such as volatile and non-volatile, removable and non-removable media and storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” refers to a signal-bearing medium that is configured to transmit instructions to the hardware of the computing device 802, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 810 and computer-readable media 806 are representative of modules, programmable device logic or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions or logic embodied on some form of computer-readable storage media including by one or more hardware elements 810. The computing device 802 may be configured to implement particular instructions and/or functions corresponding to the software and/or hardware modules. Accordingly, implementation of a module that is executable by the computing device 802 as software may be achieved at least partially in hardware, e.g., through use of computer-readable storage media and/or hardware elements 810 of the processing system 804. The instructions and functions may be executable/operable by one or more articles of manufacture (for example, one or more computing devices 802 and processing systems 804) to implement techniques, modules, and examples described herein.

The techniques described herein may be supported by various configurations of the computing device 802 and are not limited to the specific examples of the techniques described herein. This functionality may also be implemented all or in part through use of a distributed system, such as over a “cloud” 814 via a platform 816 as described below.

The cloud 814 includes or is representative of a platform 816 for resources 818. The platform 816 abstracts underlying functionality of hardware (e.g., servers) and software resources of the cloud 814. The resources 818 may include applications or data that can be utilized while computer processing is executed on servers that are remote from the computing device 802. Resources 818 can also include services provided over the Internet or through a subscriber network, such as a cellular or Wi-Fi network.

The platform 816 may abstract resources and functions to connect the computing device 802 with other computing devices. The platform 816 may also serve to abstract scaling of resources to provide a corresponding level of scale to encountered demand for the resources 818 that are implemented via the platform 816. Accordingly, in an interconnected device embodiment, implementation of functionality described herein may be distributed throughout the system 800. For example, the functionality may be implemented in part on the computing device 802 as well as via the platform 816 that abstracts the functionality of the cloud 814.

In view of the many possible embodiments to which the principles of the present discussion may be applied, it should be recognized that the embodiments described herein with respect to the drawing Figures are meant to be illustrative only and should not be taken as limiting the scope of the claims. Therefore, the techniques as described herein contemplate all such embodiments as may come within the scope of the following claims and equivalents thereof.

We claim:

1. A method comprising:
obtaining an image;
constructing a depth map for the image; and
white balancing the image based, at least in part, on the depth map.

2. The method as recited in claim 1, wherein obtaining the image comprises capturing the image using multiple cameras and constructing the depth map comprises using multiple images to construct the depth map.

3. The method as recited in claim 1, wherein obtaining the image comprises capturing the image using a single camera having phase detection pixels and constructing the depth map comprises using the image captured with the phase detection pixels.

4. The method as recited in claim 1, wherein white balancing the image comprises using a gray world auto white balance algorithm.

5. The method as recited in claim 1, wherein white balancing the image comprises using a white patch auto white balance algorithm.

6. The method as recited in claim 1, wherein white balancing the image comprises white balancing using a single illuminant.

7. The method as recited in claim 1, wherein white balancing the image comprises white balancing using multiple illuminants.

8. The method as recited in claim 1, wherein white balancing the image based, at least in part, on the depth map comprises partitioning the image into a plurality of regions based on the depth map, and white balancing multiple regions independently.

9. A method comprising:
obtaining an image;
partitioning the image into a plurality of regions;
independently white balancing at least some individual regions;
analyzing the independently white-balanced regions to produce one or more results; and
white balancing the image based on the one or more results.

10. The method as recited in claim 9, wherein white balancing at least some individual regions comprises using one or more of a gray world algorithm or a white patch algorithm.

11. The method as recited in claim 9, wherein white balancing at least some individual regions comprises determining an illuminant for each individual region.

12. The method as recited in claim 9, wherein white balancing the image comprises white balancing the image according to a single illuminant.

13. The method as recited in claim 9, wherein white balancing the image comprises white balancing the image according to multiple illuminants.

14. The method as recited in claim 9, wherein white balancing at least some individual regions comprises white balancing each of the plurality of regions.

15. The method as recited in claim 9, wherein partitioning the image into a plurality of regions comprises constructing a depth map for the image and partitioning the image based on the depth map, the depth map constructed using one of: (a) information from multiple cameras configured to capture the image or (b) information from phase detection auto focus sensors of a single camera.

16. A system comprising:
one or more processors;
one or more computer-readable storage media storing instructions which, when executed by the one or more processors, implement an assisted auto white balance module configured to process a depth map for a captured image and use the depth map to partition the captured image into a plurality of regions which are then independently white balanced by the assisted auto white balance module, the assisted white balance module being further configured to determine an illuminant for each of the white balanced regions and white balance the captured image according to one or more determined illuminants.

17. The system as recited in claim 16, wherein the assisted auto white balance module performs white balancing using one or more of a gray world algorithm or a white patch algorithm.

18. The system as recited in claim 16 embodied as a camera.

19. The system as recited in claim 16, wherein the depth map is constructed using information from multiple cameras configured to capture the image.

20. The system as recited in claim 16, wherein the depth map is constructed using information from phase detection auto focus sensors of a single camera configured to capture the image.
